(19) United States
(12) Patent Application Publication
(10) Pub. No.: US 2025/0101244 A1
(43) Pub. Date: Mar. 27, 2025

(54) KOGATION RESISTANT INK COMPOSITION AND PROCESS

(71) Applicant: MING XU, MALVERN, PA (US)

(72) Inventor: MING XU, MALVERN, PA (US)

(21) Appl. No.: 18/890,274

(22) Filed: Sep. 19, 2024

Related U.S. Application Data
(60) Provisional application No. 63/585,380, filed on Sep. 26, 2023.

(51) Int. Cl. C09D 11/328; C09D 11/322; C09D 11/38

(52) U.S. Cl. CPC C09D 11/328; C09D 11/322; C09D 11/38

(57) ABSTRACT

Heat sensitive inks are disclosed that reduce kogation in the print heads of thermal ink jet printers. The ink incorporates heat sensitive colorants/sublimation dye solid particles that are larger in size but smaller in quantity than particles that are not heat sensitive at the operating temperature of the heating elements. The smaller particles do not contribute to kogation, whereas the larger colorant particles contribute to kogation if they contact the heating element of the print heads. The smaller particles move more rapidly toward the heating element as the thermally induced bubble collapses and provide a barrier between the heating element and the heat activated or heat sensitive colorants/sublimation dye solids (hereinafter heat sensitive colorants).

This application claims the benefit of Provisional Application Ser. No. 63/585,380 filed Sep. 26, 2023

### BACKGROUND OF THE INVENTION

Thermal ink jet printers deliver ink by electric resistors (heating elements) that heat the ink at a rate of about 1,000,000° C. per second. When the when the ink reaches a temperature at 300° C. or above, the ink is vaporized and creates a bubble. As the bubble expands, an ink droplet is propelled from a chamber and out of a nozzle of a printhead. The droplet breaks away from the nozzle and onto the printing surface. The propelling bubble collapses. This creates a vacuum effect that pulls more ink into the chamber, and the entire process repeats.

Kogation is the gradual degradation of the print head of a heat-based or thermal inkjet printer due to deposition of ink components on the heating elements. Kogation reduces the efficiency and service life of the heating elements and reduces print quality. The build-up of residue on the resistor surfaces from which ink is vaporized means that less ink is vaporized per cycle and less ink is transferred to the print medium or substrate. Kogation is a particular concern where heat sensitive or heat activated materials, such as colorants, are used in the ink.

### SUMMARY OF THE INVENTION

Heat sensitive inks are disclosed that reduce kogation in the print heads of thermal ink jet printers. The ink incorporates heat sensitive colorants/sublimation dye solid particles that are larger in size but smaller in quantity than particles that are not heat sensitive at the operating temperature of the heating elements. The smaller particles do not contribute to kogation, whereas the larger colorant particles contribute to kogation if they contact the heating element of the print heads. The smaller particles move more rapidly toward the heating element as the thermally induced bubble collapses and provide a barrier between the heating element and the heat activated or heat sensitive colorants/sublimation dye solids (hereinafter heat sensitive colorants). Processes for printing the inventive heat sensitive inks are also disclosed.

### BRIEF DRAWING DESCRIPTION

FIG. 1 demonstrates liquid ink flow through a capillary of a print head of thermal ink jet printer.

FIG. 2 shows a thermally induced bubble at the heating element of a thermal ink jet printer, with heat sensitive colorant solids and small non-heat sensitive colorant solids.

FIG. 3 shows the thermally induced bubble of FIG. 3 collapsing and the resulting movement of the solids toward the heating element.

### DESCRIPTION OF PREFERRED EMBODIMENTS

The preferred ink of the invention uses heat sensitive colorants or sublimation dyes as the primary colorants. The heat sensitive colorant particles are dispersed in a liquid carrier. The heat sensitive colorant particles are insoluble or sparingly soluble in the liquid carrier, which is typically water. The heat sensitive colorant as used is substantially free of smaller solid particles. As an example, only a very small portion of the heat sensitive colorant particles are less than 70 nm in diameter.

The heat sensitive colorant is dispersed into the aqueous based carrier, along with other ink ingredients. The heat sensitive colorants comprise a sub-micron particle size distribution, with the distribution substantially free of particles less than 0.07 micron in diameter. The use of colorant particles 20 that are materially larger than the non-heat sensitive and insoluble particles 30 of the second ingredient causes the non-heat sensitive and insoluble particles to form the boundary flow layer close to the thermal inkjet ink wall where heating elements are located, while the larger heat sensitive colorant particles are pushed toward the center of the flow of the ink through the capillary 10 of the printer, and away from the heating element(s) of the printer.

A second material of the ink is a solid material that is insoluble in the carrier. The second is comprised of particles 30 that are not heat sensitive at operating temperatures of the printer to which the particles are exposed and therefore do not materially contribute to kogation. The particulate material is preferred to be substantially free of particles having a diameter that is greater than 70 nm. Proper selection of particle sizes and weight proportion of the colorant and the second material allows the aqueous liquid ink to jet through the thermal inkjet printhead with little or no kogation, or at least very little kogation as compared to prior art aqueous inks having heat sensitive colorants. Preferably, the quantity of particles of the second type of ingredient is 5 to 10 times greater than the number of heat sensitive colorant particles, and is most preferably between 5 and 15 times greater.

The thermal inkjet ink printing process and ink composition provide high resolution imaging, either through direct printing or heat transfer printing, when the heat sensitive colorants are activated or sublimated to permanently bond with the final imaged substrate. The heat sensitive colorants, for example, sublimation dye particles, provide color for the image on the imaged substrate. Printing may be accomplished by direct printing and imaging or transfer printing. Transfer printing involves ink jet printing onto a transfer medium, then transferring the image onto a final, imaged substrate.

The second ingredient is a non-heat sensitive particulate that does not contribute to kogation. The non-heat sensitive particles have no chemical or physical affinity to the heat sensitive colorants and are not substantially colored by the heat sensitive colorants. This non-heat sensitive ingredients form the particulate by particles dispersed solid form or liquid form and occupy the boundary flow layer at the wall of the printing nozzle where the printhead heating elements are, thereby isolating the heat-sensitive colorants from contacting the heating element(s).

To achieve the desired result, the number of particulates of the non-heat sensitive ingredient substantially outnumber the heat-sensitive colorant particles, so that the boundary layer flow is maintains consistency in composition without substantial fluctuation. Preferably, the number of the non-heat sensitive particles is at least 5 times more than the number heat sensitive colorant particles, and more preferably, 10 times more in number.

Liquid flow in an inkjet ink delivery system of a thermal inkjet printhead has a bulk flow and a boundary layer flow. The flow rate is different at the bulk flow as opposed to the boundary layer flow. The bulk flow is the primary volume of fluid that flows near and around the center of the capillary tube or pathway, while the boundary layer flow is a thinner layer of fluid that flows near the wall of the capillary tube or ink pathway. The flow rate of the bulk flow is of higher velocity than the flow rate velocity of the boundary layer flow, because the boundary layer flow experiences more friction and adhesion/resistance from the wall of the capillary tube or ink pathway. The difference in flow rate creates a shear stress between the bulk flow and the boundary flow, which affects the stability and uniformity of the ink droplet formation and ejection. Moreover, the boundary layer flow has more contact time with the heating elements of the thermal inkjet printhead, which can cause thermal decomposition and deposition of ink ingredients forming a residue on the heating element surface. This phenomenon, known as kogation, reduces the efficiency and service life of the heating elements, as well as affecting the print quality. Since kogation is a the build-up of residue on the resistor surfaces from which ink is vaporized to effect printing, it follows that as the insulating layer builds, the efficiency of the ink vaporization process decreases, meaning less ink is vaporized per cycle. Accordingly, less ink will be transferred to the print medium or substrate. Kogation is a concern where heat sensitive materials, such as colorants, are present. Capillary liquid flow rate in thermal inkjet printing process is used by the invention to achieve improved imaging performance and more reliable printing.

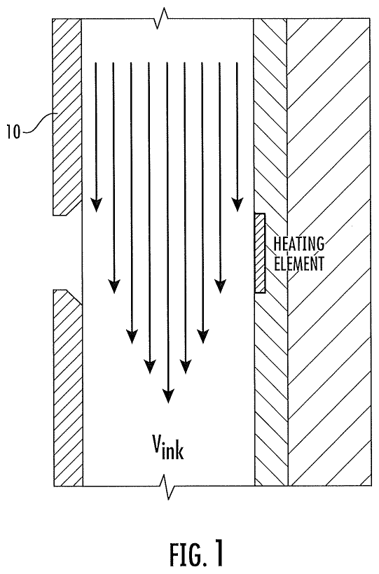

The bulk flow or mainstream flow may follow laminar flow patterns if there is a capillary force and/or steady flow rate, so that a liquid carrier and contents flow at variable rate depending on the distance to the capillary wall. Friction or adhesion to the capillary wall may be a primary main cause of a slower flow rate near the wall or edge. FIG. 1 depicts such a general flow pattern. Ink flow near the center of the ink path has the least amount of adhesion and friction from the wall, and therefore flows at the higher speed. A flow rate gradient may be naturally created along the radius or cross-section of the capillary tubing or pathway. Boundary layer flow, which is the region of fluid adjacent to the wall, is the slowest if no turbulence or other forces are present.

The flow velocity in the boundary layer may vary from zero at the capillary wall (due to the no-slip condition) to the greater freestream velocity at the center of flow. The freestream velocity is the velocity of the fluid far away from the surface of the wall, where it is least affected by the wall.

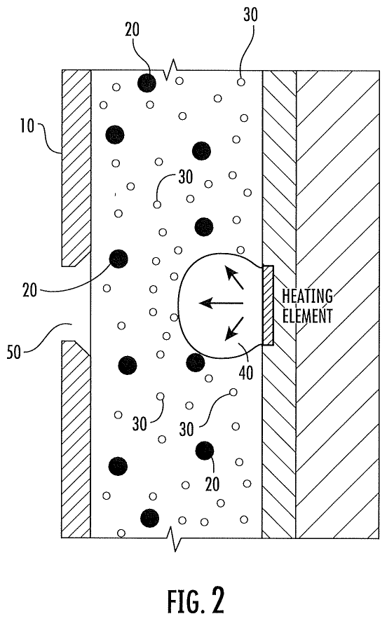

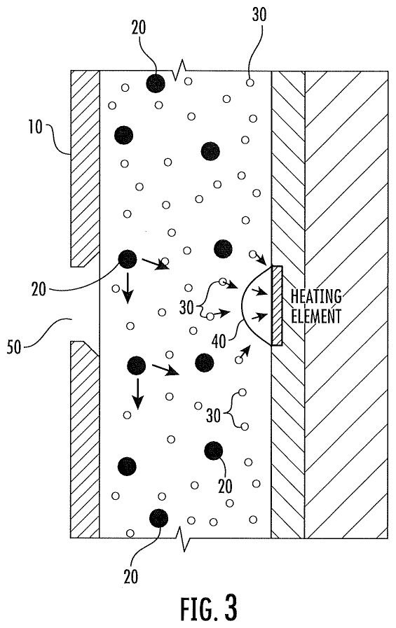

Thermal inkjet printing is a digital printing method that uses heat to vaporize ink and create images on paper or other substrates. The process involves four steps:
Heat the ink: The ink is delivered by a cartridge to a chamber where electric resistors heat it very quickly.
Generate a bubble: The heat causes the ink liquid ingredients that intimately in contact to vaporize and form a bubble 40. FIG. 2.
Propel the ink: The bubble 40 expands and pushes the downstream ink droplet out of the nozzle 50 and onto the substrate, such as paper, due to the hydraulic pressure change and transformation.
Collapse the bubble: The bubble 40 bursts and creates a vacuum that draws more ink into the chamber, and the additional ink contacts the heating element. FIG. 3.
   The process repeats for each dot of the image. The thermal inkjet printing process can produce high-resolution prints with low maintenance and cost.

Thermal inkjet printhead heating elements can reach temperatures that are above heat sensitive colorants activation or sublimation temperatures. The temperature of the heating elements is typically greater than 300° C., whereas the activation or sublimation temperature of heat sensitive colorants is typically less than 200° C. Small particles of heat sensitive colorants, for instance, low molecular weight disperse dyes having a molecular weight of 450 or less, are detrimental to the thermal printing process if the small colorant particles are in intimate contact with the heating elements. Furthermore, if the small colorant particles are in the boundary layer and come into intimate contact with the heating elements, they are the first to be vaporized when printhead heating elements fires, and leaving colorant residue deposited on the surface of the heating elements after the bubble collapses. On the other hand, non-heat sensitive particles are pushed away from the heating elements during bubble formation or firing.

In a printhead nozzle or internal ink delivery path, the ink in the boundary layer has more time in contact with the printhead heating elements, whereas ink in the bulk flow has less contact time with the heating elements. Ink components, such as heat sensitive colorants within boundary layer are more prone to kogation. Kogation reduces the efficiency and lifetime of the heating elements, as well as affecting the print quality. Another implication is that the boundary layer is more likely to experience a temperature gradient, which can affect the viscosity and surface tension of the ink. This temperature gradient may influence bubble formation and droplet ejection, as well as the stability and uniformity of the jetted ink. It is important to optimize the composition of the ink and operation of the printhead nozzle and inner ink delivery path to minimize these effects and ensure a high-performance thermal inkjet printing process. Kogation may reduce the efficiency and lifetime of the heating elements, causing nozzle failure, and may cause the heating elements to scorch the ink and ink ingredients, affecting print quality. Kogation may be the result of several factors, such as the type and composition of the ink including the percentage of solids and material decomposition temperatures, the temperature and frequency of the heating elements, and the pH and viscosity of the ink.

FIG. 2 and FIG. 3 illustrate the thermal bubble 40 formation and subsequent collapsing with inkjet ink. The large particles 20 represent heat sensitive colorants of the ink according to the invention, while the small, hollow particles 30 represent non-heat sensitive particles which vastly outnumber the heat sensitive colorants particles. During bubble 40 formation (FIG. 2), the carrier liquid and colorant particles are pushed away from the heating elements and towards the bulk fluid flow. Subsequently, in the bubble collapsing stage (FIG. 3), the carrier liquid and ink particles rapidly fill the collapsed void. Due to differences in friction, viscosity, electrostatic forces, and mechanical inertia within the heterogeneous ingredients, the smaller non-heat sensitive particles, together with carrier fluid, travel more quickly back to the surface of the heating element, effectively forming a steric and electrostatic barrier that hinders movement of the larger colorant particles toward the heating element. This is especially true when the small, non-heat-sensitive ingredient particles outnumber the large, heat-sensitive colorants. With repeated firing cycles of bubble formation and collapse, the relative concentration of large particles near the heating element surface decreases substantially, especially during high-frequency firing processes in thermal inkjet ink jetting.

The smaller non-heat sensitive particles have a smaller surface area and volume, which means they have less contact with the carrier fluid and the other particles in the bulk ink. Therefore, they encounter less resistance and move faster than the bigger particles that have a larger surface area and volume. In addition, small particles are more sensitive to temperature change and may be affected by Brownian motion. Smaller particles have lower mass and inertia, which means they are more easily moved by the impact of the carrier fluid molecules. Therefore, they exhibit faster and more erratic movement than bigger particles, which have a higher mass and inertia and are more stable in maintaining a position.

The formation of the and its bubble size in thermal inkjet printing depends on several factors, such as the ink properties, the nozzle geometry, the heating element operating temperature, and the firing frequency. Bubble size can range from several microns to 100 microns in diameter, depending on these factors. The bubble size affects the droplet size and velocity, which in turn affect the print quality and speed. Therefore, it is important to optimize the bubble size for different applications and substrates. The amount of liquid that it takes to form the bubbles through vaporization in thermal inkjet printing depends on the size and shape of the nozzle, the temperature and duration of the heating, and the properties of the ink. The volume of the ink droplet is proportional to the volume of the bubble. Therefore, to form a bubble of a certain size, it takes roughly the same amount of liquid as the volume of the droplet in a single firing. For example, if the nozzle has a diameter of 10 microns, the required ink volume may be about 1.57 picoliters (pL) for an ink droplet for a single firing (one heating wave pulse) to achieve an ink bubble of approximately 70 nanometers in diameter. The exact size of the bubble may be some variations due to factors such as ink viscosity, liquid content, surface tension, and vapor pressure.

In one embodiment of the kogation inhibiting ink according to the invention, the non-heat sensitive particulates have a weight percentage relative to the heat sensitive colorants that may be expressed as follows:

$$y = m x + b$$

wherein the “y” is the weight percentage of the non-heat sensitive ingredient comprising particles that are substantially smaller than 70 microns in diameter, and “x” is the weight percentage of the heat sensitive colorant particulate having particles that are substantially bigger than 70 microns in diameter. The weight percentage here is the total bulk ink weight. “m” is the weight percentage ratio, “b” is an adjustment parameter and may be zero at the present invention. Preferably the m is between 0.165 and 0.376, depending on the specific application such as total solid concentration, and most preferably between 0.2 and 0.35.

For example, a yellow sublimation ink comprises 3% heat sensitive colorant of the appropriate particle sizes, by total weight, while the weight of the non-heat sensitive ingredient with the appropriate particle sizes may be 0.9% of the total weight. In another example, a black sublimation ink comprising 6% heat sensitive colorant with the appropriate particle sizes and the non-heat sensitive ingredient with the appropriate particle sizes may be 1.8% in weight as the total percentage of the ink.

To control the size of the heat sensitive colorant and non-heat sensitive particles, various classification methods may be applied. These methods may include centrifugation and filtration. Different types of filtration methods may be used, alone or in combination, for liquid inks with insoluble particles, such as gravity filtration, vacuum filtration, pressure filtration, cross-flow filtration, and ultrafiltration, multiple-step filtration. Film or membrane filtration may be used for removing large particles, whereas cross-flow film/membrane filtration may be used to remove undesired small or ultra-small particles. The application combinations of different techniques for classification may yield a desired narrow particle size distribution.

Cross-flow filtration is a technique that uses a porous membrane to separate particles from a liquid based on size. The liquid flows tangentially across the membrane, creating a shear force that prevents the particles from clogging the membrane pores. The particles that are larger than the pore size are retained on the feed side of the membrane, while the particles that are smaller than the pore size pass through the membrane with the filtrate.

Cross-flow filtration can be effective for removing undesired detrimental small or extra fine particulates from liquids, especially when compared to dead-end filtration, which is another common technique. Dead-end filtration involves passing the liquid vertically through the membrane, causing the particles to accumulate on the membrane surface and form a filter cake. This filter cake can reduce the permeability and performance of the membrane over time, and requires frequent cleaning or replacement. Dead-end filtration is highly effective in removing undesirable large particulates in liquid inks.

Some of the advantages of cross-flow filtration for removing undesired small particulates are:
It can handle high concentrations of particulates without significant loss of flux or quality.
It can reduce the fouling and scaling of the membrane by continuously washing away the particulates from the membrane surface.
It can operate continuously for longer periods of time without requiring backwashing or cleaning.
It can fractionate particles by size and separate them into different streams according to their properties.

The mean particle size of the particles of the heat sensitive colorant solids in a volume of the ink jet ink for the thermal ink jet printer preferably between three (3) and ten (10) times the mean particle size of the non-heat sensitive materials in the ink jet ink for the thermal ink jet printer. The mean particle size of the particles of the heat sensitive colorant solids in a volume of the ink jet ink is not less than three (3) times the mean particle size of the non-heat sensitive materials.

The non-heat sensitive material can be either solid or aqueously miscible liquid, polymeric or non-polymeric, with thermodynamic stability in addition to the particle size and particle size distribution requirements. Preferably, these particles are either non-ionic or the same ionic charge as the dispersed heat sensitive colorant particles' charge, or which may be anionic, or a combination of the two. The non-heat sensitive material has no affinity to the heat sensitive colorants and is not the type of material used for heat sensitive colorant printing on the final substrate. More than one type of suitable material may be used alone or in combination with other suitable materials to meet the concentration (weight percentage) requirements that inhibit heat sensitive colorant particles from being retained at the boundary layer inside the thermal inkjet ink printhead nozzles or ink pathway where heating elements reside.

Heat sensitive colorants suitable for use may include various disperse dyes or sublimation dyes that are activated or sublimed by applying heat to the printed substrate or transfer substrate. They typically are insoluble or sparingly soluble in water. Generally, the heat activation temperature does not exceed 450° F., and most preferably, does not exceed 410° F. Examples of colorants, in varying ratios, include but are not limited, to C.I. Disperse Orange 13, 29, 31:1, 33, 49, 54, 55, 66, 73, 119 and 163; C.I. Disperse Red 4, 11, 54, 60 72, 73, 86, 88, 91, 92, 93, 111, 126, 127, 134, 135, 143, 145, 152, 153, 154, 159, 164, 167:1, 177, 181, 204, 206, 207, 221, 258, 278, 283, 288, 311, 323, 343, 348 and 356; C.I. Disperse Violet 33; C.I. Disperse Blue 4, 13, 56, 73, 113, 128, 148, 154, 158, 165, 165:1, 165:2, 183, 197, 201, 214, 224, 225, 257, 266, 267, 287, 358, 359, 360, 379, Disperse Brown 26, 27; and Disperse Yellow 5, 42, 54, 64, 79, 82, 83, 93, 99, 100, 119, 122, 124, 126, 160, 184:1, 186, 198, 199, 204, 224 and 237. Depending on the specific application, other organic and inorganic pigments, and soluble and insoluble dyes, such as direct dyes, acid dyes, reactive dyes, vat dyes, cation dyes, basic dyes, luco dyes, thermochromatic, and photochromatic colorants may also be used.

Heat sensitive colorants may be pre-dispersed and stabilized with various dispersants, emulsifiers, milling aids, chemical agents, and other common inkjet formulation materials. Preferably, they are stabilized with non-ionic or anionic polymeric materials that do not withhold the colorant during heat activation process, whether through heat fixing during direct printing or through further transfer from the imaged intermediate to the final substrate. Polymer dispersants with both steric and electrostatic capability are preferred to form and stabilize heat sensitive colorant in ink carrier fluid for the present invention.

Non-heat sensitive ingredients for the thermal inkjet ink are those that can withstand the high temperatures and pressures involved in the printing process without undergoing undesirable changes. Some of the characteristics of these ingredients are:
They do not sublimate under a few hundred degrees Celsius, especially not under the conditions with normal sublimation colorant during imaging processes. Sublimation is the process of changing from a solid to a gas without passing through a liquid phase. Sublimation colorants are dyes that can sublimate and transfer to a substrate when heated. If the other ingredients in the ink also sublimate or decompose, they may interfere with the color quality and durability of the print.
They have no affinity for and do not bond with sublimation colorants, either chemically or physically, either temporarily or permanently. Bonding between the ingredients and the colorants may affect the solubility, viscosity, and stability of the ink, as well as the print quality and performance.
They do not decompose at thermal inkjet ink operating conditions, and especially do not decompose when in contact with thermal inkjet printhead heating elements. Decomposition of the ingredients may result in kogation, clogging of the nozzles, formation of deposits on the printhead, or emission of harmful gases.
They are either colorless, transparent, or translucent, or have a color that is consistent with the ink color and do not interfere the resulting printed image.

Some general examples of non-heat sensitive ingredients for thermal inkjet ink are:
Polymers: These are large molecules composed of repeating units called monomers. Polymers can provide various functions in thermal inkjet ink, such as improving adhesion, durability, gloss, and water resistance. Polymers used in thermal inkjet ink are polystyrene, poly(benzyl methacrylate), and epoxy are among the choices. Dispersions in the form of latex may also be included in this category. These are special type of emulsion or sol in which each colloidal particle contains multiple polymeric macromolecules, either natural or synthetic.
Inorganic nanoparticles and colloidal systems: These are particles with sizes between 1 nm and 100 nm that are made of metal or metal oxide materials. Inorganic nanoparticles can enhance the optical, electrical, magnetic, or catalytic properties of thermal inkjet ink. Some examples of inorganic nanoparticles used in thermal inkjet ink are silica, iron oxide, and quantum dots.
Pigments: These are insoluble particles that provide color to thermal inkjet ink by reflecting or absorbing light. Pigments can offer higher color strength, light stability, and heat resistance than dyes. Some examples of pigments used in thermal inkjet ink are titanium dioxide, carbon black, and organic pigments.

Some of the specific size-limit examples of aqueous based non-heat sensitive non-affinitive ingredients include but not limited to:
Nanosphere Size Standards from Thermo Scientific: These are polystyrene particles with diameters ranging from 20 nm to 900 nm, available as aqueous suspensions.
PDMA 71-PBzMA 100 from University of Sheffield: These are diblock copolymer nanoparticles with a core of poly(benzyl methacrylate) and a shell of poly(2-(dimethylamino)ethyl methacrylate), with a diameter of about 30 nm.
Nanopox from Evonik: These are epoxy-functionalized silica nanoparticles with diameters between 20 nm and 50 nm, available as aqueous dispersions.
Nanobyk from Byk: These are surface-modified inorganic nanoparticles with diameters between 10 nm and 50 nm, available as aqueous dispersions.
Nanocryl from Nanophase Technologies: These are metal oxide nanoparticles with diameters between 10 nm and 60 nm, available as aqueous dispersions.
Nanoperm from Nanogate: These are iron oxide nanoparticles with diameters between 10 nm and 40 nm, available as aqueous dispersions.
Nanocolors from Nanograde: These are pigment nanoparticles with diameters between 5 nm and 50 nm, available as aqueous dispersions.
Nanodispersions from Nanocs: These are organic dye or fluorescent nanoparticles with diameters between 5 nm and 40 nm, available as aqueous dispersions.
Nanodots from Sigma-Aldrich: These are quantum dot nanoparticles with diameters between 2 nm and 10 nm, available as aqueous dispersions.

Preferably, a matching color of both heat sensitive colorants and non-heat sensitive ingredient may be used in combination so that the visual color consistency and accuracy of the corresponding ink color can be maintained for final image requirements.

TABLE I
General Ink Composition

| Ingredient | Weight percentage (%) |
|---|---|
| Heat sensitive colorant | 1-9 |
| Non-heat sensitive dispersion | 0.5-6 |
| Ink physical property adjustment ingredients | 0.5-25 |
| Solvent/cosolvent | 10-60 |
| Carrier | 30-90 |

The exact percentages of each ingredient may vary depending on the desired properties and performance of the ink. Some examples of ink physical property adjustment ingredients are surfactants, pH value adjustment/buffers, biocides, humectants, biocide, viscosity control agent, and chelating agents. Some examples of solvents/cosolvents are glycerol, ethylene glycol, and diethylene glycol, etc. Some examples of carriers are water, ethanol, isopropanol, and DESs.

In a preferred embodiment, the present invention uses thermal inkjet printers with installed docking station and wiper. A thermal inkjet printer uses a print head that contains tiny nozzles that heat up and eject ink droplets onto the printing medium, either paper or other type. The print head moves back and forth across the paper, creating the desired image or text. However, over time, the print head can get clogged with dried ink, fibers/lint, dust, or debris, which can affect the print quality and performance. To prevent this, the present thermal inkjet printers have a wiper and a docking station that clean and protect the print head.

A wiper is a thin rubber blade that slides across the surface of the print head, removing any excess ink or dirt that may have accumulated on the nozzle plate. The wiper also helps to prevent ink from leaking or dripping from the print head when it is not in use. The wiper is usually located on one side of the printer, near the end of the print head's travel path.

A docking station is a special area where the print head rests when it is not printing. The docking station provides a wet cap or optionally a vacuum seal that covers the nozzle plate, preventing it from drying out or getting exposed to ambient air. The wet cap is a sponge-like material that is soaked with a cleaning solution that keeps the nozzles moist and dissolves any ink residue. The vacuum seal is a rubber gasket that creates an air-tight chamber around the nozzles, preventing any air bubbles or ink evaporation. The docking station also has a suction pump that can draw out any air or ink from the nozzles and collect it into an absorber or container.

By using a wiper and a docking station, thermal inkjet printers of present invention can maintain their print quality and performance, as well as extend the life of their print heads. These features aid in ensuring reliable and consistent printing results.

Optionally, the present invention is further equipped with a novel feature of adding a heating element to the thermal inkjet printer to provide temperature adjustment and accelerate printed image drying and/or adjust the viscosity of the ink in the ink cartridge or ink delivery mechanism during printing process. This feature is especially useful when deep eutectic solvent(s) or high viscosity cosolvents are used as the ink carrier ingredients, where viscosity of the ink is sensitive but also adjustable by temperature control.

The present invention may provide a thermal inkjet ink application as another embodiment. This application uses a thermal inkjet printhead or jetting mechanism with an internal ink recirculation system that keeps the ink in motion with an adjustable and preferred flow rate. This prevents the ink from settling, agglomerating, or precipitating, which can affect the print quality and reliability. The ink recirculation system may operate before reaching the jetting chamber, where the ink is heated and ejected through the printing nozzles. The system may also replenish the jetting chamber after the printing process to ensure a continuous and consistent ink supply with steady pressure and flow. Each color of ink may comprise its own independent recirculation system to avoid mixing or contamination of different inks. Inline filtration may also be installed and performed to remove undesirable fiber, dust particles, agglomerations, and air bubbles. Optionally, a pressure regulator may also be installed to regulate ink circulation and jetting fluid supply.

The ink recirculation feature offers several advantages. First, it can handle a wide range of inks, including ink solid load (or solid percentage), without compromising the performance or durability of the printhead or jetting mechanism. Second, it can reduce the risk of nozzle clogging, air bubbles, or ink starvation, which can cause print defects or failures. Third, it can improve the print speed and resolution, by ensuring a uniform and optimal ink temperature and viscosity across the jetting chamber and the printing nozzles. Fourth, it can lower the maintenance and operational costs, by minimizing the need for cleaning cycles or printhead replacements. Preferably, the present thermal inkjet printing is a full color printing process.

The present invention can be used for either monochrome (single-color) or multicolor ink applications. For multicolor applications, a full-color process is preferred, using cyan, yellow, magenta, and black (CYMK) inks to produce a wide range of colors and shades. Additionally, light colors, such as light cyan, light magenta, light yellow, or light black (gray), and other vector or spot colors, may be used to achieve more desirable or special imaging results. The present invention can support different color modes and profiles, depending on the type and quality of the media and the intended use of the printed images.

The present invention is applicable for various types of thermal inkjet printers and substrates, such as paper, fabric/textile materials, plastic, metal, or ceramic. The present invention is also compatible with different types of heat sensitive colorants or sublimation dyes, such as carbopol (crosslinked polyarylic acid), quantum dots, or organic pigments. The present invention offers a simple, cost-effective, and environmentally friendly solution for enhancing kogation-free thermal inkjet printing using heat sensitive colorants, water, DESs or high viscosity cosolvents as ink carriers.

What is claimed:

1. An ink jet ink for a thermal ink jet printer, comprising:
heat sensitive colorant solids dispersed within a liquid carrier;
non-heat sensitive materials that are dispersed within the liquid carrier;
wherein particles of the heat sensitive colorant solids are materially larger than particles of the non-heat sensitive materials, and wherein the number of particles of the non-heat sensitive materials in a volume of the ink jet ink for the thermal ink jet printer is substantially greater than the number of particles of the heat sensitive colorant solids in the volume of the ink jet ink for the thermal ink jet printer.

2. The ink jet ink for a thermal ink jet printer described in claim 1, wherein the quantity of particles of the non-heat sensitive materials in a volume of the ink jet ink for the thermal ink jet printer is not less than five (5) times the quantity of particles of the heat sensitive colorant solids in the volume of the ink jet ink for the thermal ink jet printer.

3. The ink jet ink for a thermal ink jet printer described in claim 1, wherein the mean particle size of the particles of the heat sensitive colorant solids in a volume of the ink jet ink for the thermal ink jet printer is not less than three (3) times the mean particle size of the non-heat sensitive colorant materials in the volume of the ink jet ink for the thermal ink jet printer.

4. The ink jet ink for a thermal ink jet printer described in claim 1, wherein the number of particles of the non-heat sensitive materials in a volume of the ink jet ink for the thermal ink jet printer is not less than five (5) times the number of particles of the heat sensitive colorant solids in the volume of the ink jet ink for the thermal ink jet printer, and the mean particle size of the particles of the heat sensitive colorant solids in a volume of the ink jet ink for the thermal ink jet printer is not less than (3) times the mean particle size of the non-heat sensitive materials in the volume of the ink jet ink for the thermal ink jet printer.

5. The ink jet ink for a thermal ink jet printer described in claim 1, wherein the non-heat sensitive materials do not contribute to color of an image printed with the ink jet ink for the thermal ink jet printer.

6. The ink jet ink for a thermal ink jet printer described in claim 1, wherein the non-heat sensitive materials have no physical or chemical affinity for the heat sensitive colorant solids in the ink jet ink for the thermal ink jet printer.

7. The ink jet ink for a thermal ink jet printer described in claim 1, wherein the non-heat sensitive materials do not decompose or sublimate at an operating temperature of the thermal ink jet printer.

8. The ink jet ink for a thermal ink jet printer described in claim 1, wherein in use, the non-heat sensitive materials move toward a heating element of the thermal ink jet printer as a heat induced bubble contracts and shield the heat sensitive colorant solids from the heating element.

9. The ink jet ink for a thermal ink jet printer described in claim 1, wherein in use, the non-heat sensitive materials move toward a heating element of the thermal ink jet printer as a heat induced bubble contracts and deter movement of the heat sensitive colorant solids toward the heating element.
